(19) United States
(12) Patent Application Publication
(10) Pub. No.: US 2005/0232130 A1
(43) Pub. Date: Oct. 20, 2005

(54) Production method for photoresist master, production method for optical recording medium-producing stamper, stamper, phtoresist master, stamper intermediate element and optical recroding medium

(75) Inventors: Hisaji Oyake, Tokyo (JP); Hiroaki Takahata, Tokyo (JP); Kenji Shirasuna, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/515,404

(22) PCT Filed: May 30, 2003
(86) PCT No.: PCT/JP03/06861

§ 371 Date: Nov. 23, 2004

(30) Foreign Application Priority Data
Jun. 5, 2002 (JP) 2002-164019

(51) Int. Cl. G11B 7/24

(52) U.S. Cl. 369/275.4

(57) ABSTRACT

A stamper (36) used for fabricating an optical recording medium is fabricated by forming a convexo-concave pattern (22) without development of a photoresist layer (16).

A fabrication method of the stamper used for fabricating an optical recording medium includes: forming a light-absorbing layer (14) and the photoresist layer (16) on a glass substrate (10); forming the convexo-concave pattern (22) of undeveloped photoresist by irradiating the photoresist layer (16) with laser light from a surface of the photoresist layer that is opposite to the light-absorbing layer (14) so as to remove a part of the photoresist layer by energy of the laser light, thereby fabricating a photoresist master (26); forming a metal thin layer (28) on the convexo-concave pattern (22) in the photoresist master (26); forming a metal layer (30) on the metal thin layer (28) by electro-plating; and forming the stamper (36) by separating the metal thin layer (28) and the metal layer (30) from the photoresist master (26).

### TECHNICAL FIELD

The present invention relates to a stamper used for fabricating an optical recording medium having a convexo-concave pattern such as grooves and pre-pits, a photoresist master for fabricating the stamper, a stamper intermediate, a fabrication method of a photoresist master, a fabrication method of a stamper that uses the above-mentioned photoresist master, and an optical recording medium fabricated by using that stamper.

### BACKGROUND ART

An optical disc, or a kind of optical recording media, is now classified into two types, i.e., an optical recording disc that is recordable or rewritable, and a read-only disc on which information is recorded in advance.

On a disc substrate in such an optical recording disc, a groove (guide groove) used for tracking or the like is formed. On the disc substrate, a recording layer containing a phase-change material or an organic dye material is further formed. When the recording layer is irradiated with a laser beam, chemical change, and/or physical change is caused in the recording layer, so that a recording mark is formed. On the other hand, on a disc substrate in such a read-only disc, recording marks (information pits) are formed as part of a convexo-concave pattern in advance. When these recording marks are irradiated with a laser beam for reading, the amount of reflected light is changed. Thus, by detecting that change, information can be read (reproduced).

In order to fabricate a disc substrate having a convexo-concave pattern such as a groove or information pits, a stamper is used on which a negative pattern of that convexo-concave pattern (this negative pattern is also one type of convexo-concave patterns) is formed in advance. For example, injection molding is carried out by using a mold in which such a stamper is fixed in a cavity, thereby transferring the above-mentioned negative pattern onto a resin filled in the mold. This is a typical method for fabricating such a disc substrate.

A stamper having a convexo-concave pattern is generally formed by a plate of metal containing Ni or the like. In a fabrication procedure of that stamper, a photoresist master having a negative pattern of the convexo-concave pattern of the stamper is formed in advance. Then, a metal layer is formed on that photoresist master by plating. Subsequently, the metal layer is removed from the photoresist master, and a predetermined process such as a surface cleaning is performed. In this manner, the stamper is obtained.

Referring to FIG. 4, in which a conventional photoresist master 1 is shown, a fabrication procedure of this photoresist master 1 will be described. First, a photoresist layer 3 is formed on a glass substrate 2. Then, the photoresist layer 3 is exposed to light by using a patterning beam such as a laser beam, and then a pattern of a latent image is developed. In this manner, the photoresist master 1 in which a convexo-concave pattern 4 is formed in the photoresist layer 3 is obtained.

In order to fabricate a stamper 5 by plating using that photoresist master 1, first, a thin layer 6 of metal containing Ni or the like is formed on the surface of the convexo-concave pattern 4 by electroless deposition or the like, as shown in FIG. 5, so that the photoresist master 1 made conductive.

Then, plating is performed by applying a current while the metal thin layer 6 is used as a primary coat layer, thereby forming a metal layer 7 containing Ni or the like. By separating the metal thin layer 6 and the metal layer 7 from the photoresist master 1, the stamper 5 having the convexo-concave pattern 4 transferred thereon can be obtained.

In recent years, a convexo-concave pattern such as a groove become finer with the increase of the capacity of an optical recording medium. Therefore, an error in the shape of the convexo-concave pattern has larger effects on the accuracy of recording and reproduction. Thus, it is demanded to form the convexo-concave pattern on a disc substrate with sharpness. In order to achieve this, it is necessary to form the convexo-concave pattern of the photoresist layer 3, that serves as the base of the convexo-concave pattern to be formed on the disc substrate, with high precision (with sharpness).

The minimum width of the latent image pattern that is formed in the photoresist layer 3 is restricted by a spot diameter of the laser beam that reaches the photoresist layer 4. The spot diameter w is represented as w=k·λ/NA where λ is the wavelength of the laser beam and NA is numerical aperture of an objective lens of an illumination optical system. Incidentally, k is a constant determined by the shape of the aperture of the objective lens and the intensity distribution of incident rays.

However, it is known that, in the case where the photoresist layer 3 is excessively thin although the pattern to be formed has a width that does not exceed the limit of the spot diameter logically, the sharpness of the convexo-concave pattern transferred onto the stamper is not sufficient because the convexo-concave pattern is too shallow or the shape of the convexo-concave pattern is rounded (this rounded shape is called as a “slack” of the pattern). It is generally considered that such lack of sharpness is caused by fluctuation of the thickness of the photoresist layer 3 (this is called as “reduction of the layer”) that occurs in the exposure and development process. This fluctuation of the thickness was considered to be caused by excessive exposure of the photoresist layer 3 to the laser beam reflected between the photoresist layer 3 and the glass substrate 2.

The inventor of the present application found that, in order to solve the aforementioned problem, it was effective to form a light-absorbing layer between the glass substrate 2 and the photoresist layer 3 (this solution was unknown at least at the time of filing of the present application). In this case, the light-absorbing layer can absorb the laser beam, thereby suppressing reflection of the laser beam. Thus, it is possible to expose and develop the pattern more sharply, as compared with the conventional technique.

Moreover, as a result of further consideration, the inventor of the present application considered that the convexo-concave pattern formation by exposure and development (in a so-called photon mode) had a limitation on the spot diameter and formation of a finer convexo-concave pattern also had a limitation.

### DISCLOSURE OF THE INVENTION

The present invention was made in order to form a finer convexo-concave pattern. It is an object of the present invention to provide a fabrication method of a stamper used for fabricating an optical recording medium, in which an irradiated portion of a photoresist layer is directly removed by irradiating the photoresist layer with a laser beam so as to form a highly precise convexo-concave pattern without development process. Another object of the present invention is to provide a stamper, a photoresist master, a stamper intermediate, and an optical recording medium fabricated by using the same.

The inventor of the present application made researches concerning a fabrication method of an optical recording medium and the like, and proposes here a method for forming a convexo-concave pattern on a stamper with sharpness by using an active energy beam that is either of an electromagnetic wave including laser light and radiation (including a particle beam) and an electron beam.

In other words, the problems can be solved by the following present invention.

(1) A fabrication method of a photoresist master comprising the steps of: forming at least a light-absorbing layer and a photoresist layer on a substrate in that order; and forming a convexo-concave pattern by irradiating the photoresist layer with an active energy beam from a surface of the photoresist layer opposite to a surface thereof that is in contact with the light-absorbing layer to remove photoresist at an irradiated portion of the photoresist layer.

(2) A fabrication method of a stamper used for fabricating an optical recording medium, comprising the steps of: forming at least a light-absorbing layer and a photoresist layer on a substrate in that order; forming a convexo-concave pattern to fabricate a photoresist master by irradiating the photoresist layer with an active energy beam from a surface of the photoresist layer opposite to a surface thereof that is in contact with the light-absorbing layer to remove photoresist at an irradiated portion of the photoresist layer; forming a metal thin layer on the convexo-concave pattern in the photoresist master; forming a metal layer on the metal thin layer by electro-plating; and forming a stamper by separating the metal thin layer and the metal layer from the photoresist master.

(3) The fabrication method of a stamper used for fabricating an optical recording medium according to (2), wherein the active energy beam for forming the convexo-concave pattern is an electromagnetic wave having a wavelength in an ultraviolet region.

(4) The fabrication method of a stamper used for fabricating an optical recording medium according to (2) or (3), wherein the stamper used for fabricating an optical recording medium has a shape of a disc, a forming pitch of the convexo-concave pattern in a disc-radial direction is smaller than 0.6 μm, and irradiation with the active energy beam is performed to satisfy 0.75t<θ<1.4t so as to form a concave portion where a depth of the convexo-concave pattern is t nm and an angle of inclination of a sidewall face of the convexo-concave pattern at a level of t/2 is θ°.

(5) A stamper used for fabricating an optical recording medium, having a convexo-concave pattern on a surface thereof formed in advance, wherein the stamper is fabricated by the fabrication method according to any one of (2) to (4).

(6) A stamper used for fabricating an optical recording medium, having a convexo-concave pattern on a surface thereof formed in advance, wherein a forming pitch of the convexo-concave pattern in a disc-radial direction is smaller than 0.6 μm, and the convexo-concave pattern satisfies 0.75t<θ<1.4t where a depth of the convexo-concave pattern is t nm and an angle of inclination of a sidewall face of the convexo-concave pattern at a level of t/2 is θ°.

(7) A photoresist master comprising: a substrate; a light-absorbing layer formed on the substrate; and a photoresist layer formed to be in contact with the light-absorbing layer, wherein the photoresist layer has a convexo-concave pattern formed by directly removing a part of photoresist at the photoresist layer by irradiation with an active energy beam.

(8) A stamper intermediate comprising: a substrate; a light-absorbing layer formed on the substrate; a photoresist layer formed to be in contact with the light-absorbing layer, the photoresist layer having a convexo-concave pattern formed by directly removing a part of photoresist at the photoresist layer by irradiation with an active energy beam; a metal thin layer formed on the convexo-concave pattern; and a metal layer formed on the metal thin layer by electro-plating.

(9) A disc-shaped optical recording medium in which a convexo-concave pattern including at least one of information pits and a groove for guiding a laser beam is formed, wherein a forming pitch of the convexo-concave pattern in a disc-radial direction is smaller than 0.6 μm, and the convexo-concave pattern satisfies 0.75t<θ<1.4t where a depth of the convexo-concave pattern is t n=and an angle of inclination of a sidewall face of the convexo-concave pattern at a level of t/2 is θ°.

(10) The optical recording medium according to (9), fabricated using the stamper according to claim (5) or (6).

### BRIEF DESCRIPTION OF THE DRAWINGS

FIG. 1 is a cross-sectional view generally showing a fabrication method of a stamper used for fabricating an optical recording medium according to an exemplary embodiment of the present invention.

FIG. 2 is a schematic view showing an angle of inclination in a convexo-concave pattern in a photoresist master.

FIG. 3 is a cross-sectional view generally showing processes in which a mother disc and a child disc are fabricated from the stamper (or the master disc) and an optical recording medium is fabricated from the disc.

FIG. 4 is a cross-sectional view of a conventional photoresist master.

FIG. 5 is a cross-sectional view showing a state in which a stamper is fabricated by using the conventional photoresist master.

### BEST MODE FOR CARRYING OUT THE INVENTION

Various exemplary embodiments of this invention will be hereinafter described in detail with reference to the drawings.

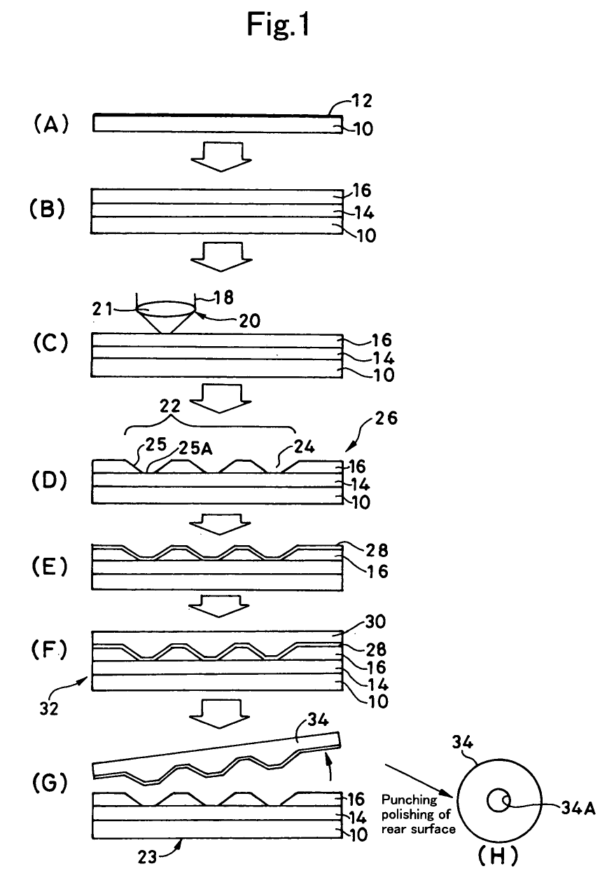

First, referring to FIG. 1, a fabrication procedure of a stamper used for fabricating an optical recording medium, according to the exemplary embodiment of the present invention will be described.

As shown in FIG. 1(A), first, coupling agent 12 is applied onto a glass substrate 10. On the thus applied coupling agent 12, a light-absorbing layer 14 and a photoresist layer 16 are formed in that order, as shown in FIG. 1(B).

It is preferable that the light-absorbing layer 14 contain an organic compound having a light-absorbing property (hereinafter, referred to as a light-absorbing agent). It is also preferable that, as the light-absorbing agent, at least one compound selected from photoinitiators, co-initiator, and dyes be used. In general, the photoinitiator is an organic compound that is used with a photocuring resin and causes generation of radicals when absorbing light such as ultraviolet rays. On the other hand, the co-initiator is not activated by irradiation with ultraviolet rays. However, in case of using the co-initiator with the photoinitiator, an initiation reaction is accelerated as compared with the case where the photoinitiator is used alone, so that a photocuring reaction makes progress efficiently. The co-initiator is stable, whereas the photoinitiator causes generation of radicals and is decomposed. Thus, according to the present invention, it is more preferable to use the co-initiator. As the co-initiator, aliphatic amine or aromatic amine is largely used. According to the present invention, it is preferable to use as the co-initiator at least one of 4,4′-bis(dimethylamino)benzophenone, 4,4′-bis(diethylamino)benzophenone, ethyl 4-dimethylaminobenzoate, (n-butoxy)ethyl 4-dimethylaminobenzoate, isoamyl 4-dimethylaminobenzoate, and 2-ethylhexyl 4-dimethylaminobenzoate. In particular, it is preferable to use benzophenone type compounds.

It is usually preferable that the light-absorbing layer containing the light-absorbing agent be formed in the following procedure. First, a light-absorbing agent is dissolved in a solvent so as to prepare a solution to be applied. The solution is prepared to contain a thermally cross-linking compound in addition to the light-absorbing agent, if necessary. After the solution was applied so as to form a layer containing the light-absorbing agent and the thermally cross-linking compound, the applied layer is heated to be cured. Then, a photoresist layer is formed on the cured layer. In this manner, mixing of the light-absorbing layer 14 and the photoresist layer 16 can be suppressed. Moreover, various additives such as an adhesive auxiliary agent that improves adhesion between the light-absorbing layer 14 and the photoresist layer 16, an absorption agent, and a surfactant, may be contained in the solution to be applied, if necessary.

Then, as shown in FIG. 1(C), the photoresist layer 16 is irradiated with a laser beam 18 for patterning via an illumination optical system 20.

This irradiation is carried out in such a manner that the power of the irradiated laser beam is set to a predetermined value or more at a portion of the photoresist layer 16 at which a concave portion is to be formed, i.e., a portion that corresponds to a concave portion in an optical recording medium 40 as a final product or a convex portion by being reversed, but is set to be zero or smaller than a threshold value at a portion where no concave portion is to be formed. In this manner, a predetermined convexo-concave pattern 22 is directly formed in the photoresist layer 16, as shown in FIG. 1(D). In other words, the convexo-concave pattern 22 is formed without development to obtain a photoresist master 26.

Incidentally, the laser used in this exemplary embodiment is an ultraviolet laser and an objective lens 21 in the illumination optical system 20 has a numerical aperture NA=0.90.

When the aforementioned laser beam 18 for patterning is made incident on the photoresist layer 16 with the power equal to or larger than a predetermined power, the laser beam is absorbed by the light-absorbing layer 14 and is converted into heat energy. This heat partially removes the photoresist layer 16 by thermal decomposition and/or generated gas, so that a concave portion 24 having a sharp edge is formed. Thus, the photoresist master 26 shown in FIG. 1(D) is formed.

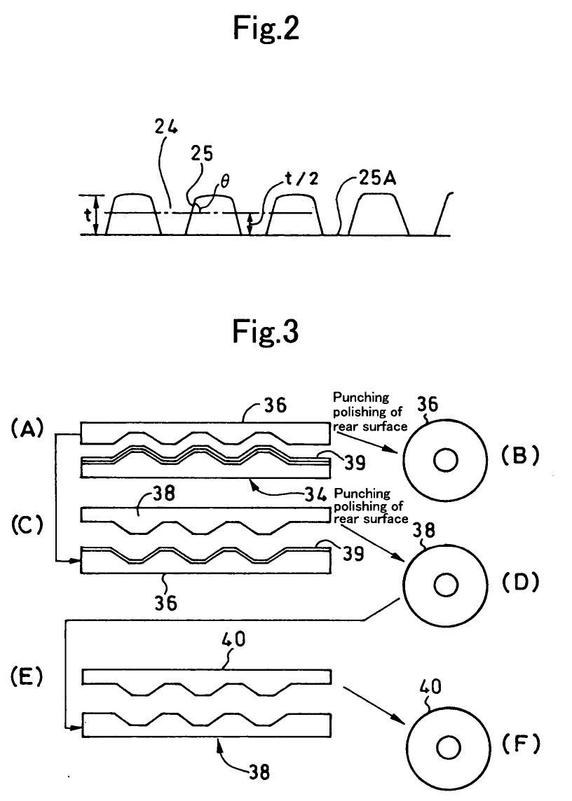

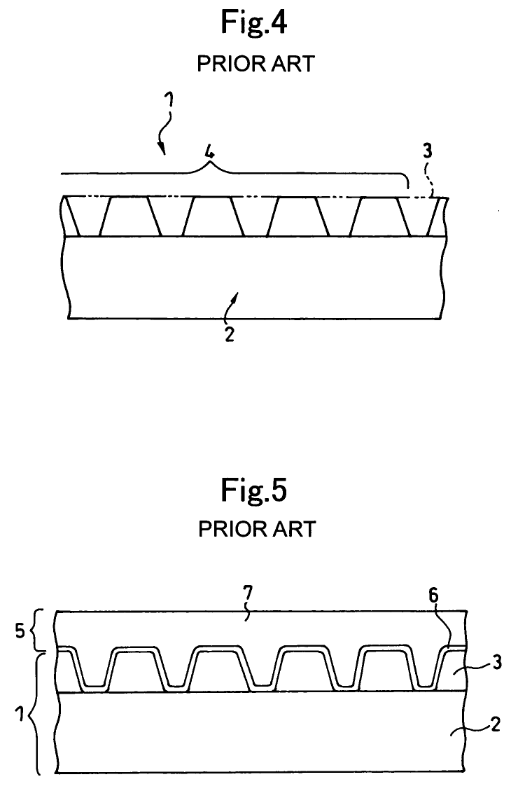

As shown in FIG. 2, an angle of inclination θ[°] is an angle formed by a sidewall face 25 of the concave portion 24 at a level of t/2 [m] from the bottom face 25A where t [nm] is the depth of the concave portion 24, and a plane (shown with the chain line in FIG. 2) parallel to a bottom face 25A, the surface of the light-absorbing layer 14, or the surface of the glass substrate 10. This angle of inclination satisfies 0.75t<θ<1.4t even in the case where a pitch of the convexo-concave pattern 22 in a disc-radial direction is smaller than 0.6 μm, in particular, is equal to or smaller than 0.35 μm.

Therefore, the forming pitch of the concave portions 24 in the convexo-concave pattern 22 (the forming pitch of 0.6 μm or less, in particular, 0.35 μm or less) and the width thereof can be made small, thus forming a finer convexo-concave pattern 22.

Next, as shown in FIG. 1(E), a metal thin layer 28 is formed on the aforementioned convexo-concave pattern 22 by electroless deposition. This metal thin layer 28 is a Ni thin layer, for example.

Next, a current is applied to the surface of the metal thin layer 28 while the metal thin layer 28 is used as a conductor, thereby forming a metal layer 30 formed of Ni or the like, by electro-plating. Thus, as shown in FIG. 1(F), a stamper intermediate 32 with the photoresist master is formed.

Next, as shown in FIG. 1(G), a master disc (stamper) 34 including the metal thin layer 28 and the metal layer 30 is removed from the stamper intermediate 32.

The master disc 34 may be used as a stamper, after punching at its central portion 34A and its outer peripheral portion and polishing of its rear surface are carried out to place the master disc 34 in a state shown in FIG. 1(H). However, in place of punching, a process shown in FIG. 3(A) may be carried out to fabricate a mother disc 36 shown in FIG. 3(B), and thereafter a number of child discs (stampers) 38 may be fabricated in a process for making a number of copies of the mother disc 36, as shown in FIG. 3(C) to serve them as stampers. Moreover, the mother disc 36 may be used as a stamper. The reference numeral 39 in FIG. 3 denotes a peeling-off processing layer.

One of these stampers obtained is placed in a mold (not shown), and injection molding is carried out to obtain a substrate 40 for an optical recording medium made of a resin as shown in FIG. 3(E). The substrate 40 for an optical recording medium is a final product, shown in FIG. 3(F).

In a system using blue laser having a wavelength of about 405 nm and an objective lens having numerical aperture of about 0.85 for recording and/or reproduction, the thickness of the photoresist layer 16 in the aforementioned exemplary embodiment is set to 60 nm for forming an information pit or about 30 nm for forming a groove as a laser-beam guide, for example, and is determined in accordance with the type of the convexo-concave pattern.

Moreover, the thicker light-absorbing layer 14 can convert laser beam incident thereon more efficiently into heat energy. The thickness of the light-absorbing layer 14 is optimized to fall within a range from 1 to 300 nm in accordance with the type of the incident laser beam.

In addition, the aforementioned angle of inclination θ is transferred from the photoresist master to the master disc 34 or to the child disc 38 via the mother disc 36 with approximately no change, in the procedure shown in FIG. 1. Thus, in the substrate 40 for an optical recording medium, or the final product thus fabricated, an angle of inclination of a sidewall face of an information pit and/or a groove can be formed larger, as compared with a conventional technique. Therefore, it is possible to highly precisely form a sharp convexo-concave pattern and increase the recording capacity.

In the above exemplary embodiment, the convex-concave pattern is formed by using a laser beam. However, the formation of the convexo-concave pattern can be carried out by using an electromagnetic wave such as laser light or radiation including a particle beam such as an electron beam. In other words, the convexo-concave pattern can be formed by an active energy beam.

### EXAMPLES AND COMPARATIVE EXAMPLES

After a layer of coupling agent was formed on a polished glass substrate, a light-absorbing layer was formed on the glass substrate by spin-coating. As a solution to be applied, SWK-T5D60 (manufactured by Tokyo Ohka Kogyo Co., Ltd.) containing 4,4′-bis(diethylamino)benzophenone as a light-absorbing agent was used. The applied layer was baked at a temperature of 200° C. for 15 minutes, so that the applied layer was cured and residual solvent was removed. In this manner, light-absorbing layers having different thicknesses shown in Table 1 as Examples 1 through 4 and Comparative Example 1 were obtained. Next, a photoresist (DVR100 manufactured by ZEON Corporation) was spin-coated onto the light-absorbing layer. The photoresist was then baked so as to vaporize residual solvent, so that a photoresist layer having a thickness of 60 nm was formed.

Then, using a cutting machine manufactured by Sony Corporation, in order to form information pits, a UV laser beam (wavelength=351 nm) was made incident on the photoresist layer via an illumination optical system having NA=0.90. Thus, a convexo-concave pattern was formed and a photoresist master was obtained.

When irradiating with the laser beam, the power of the laser beam was gradually increased from a small level and reached to a certain level. That level at which the formation of the information pit (concave portion) started is shown in Table 1 as a threshold value.

The convexo-concave pattern thus formed was observed by an AFM (atomic force microscope) to check its shape. The angle of inclination θ in the concave portion and the width and depth of the pit, which were obtained from the result of the above observation, are shown in Table 1. The pitch of the shape of the convexo-concave pattern in the disc-radial direction was set to 0.32 μm. Here, the probe of the AFM is made of a Si single crystal having a half cone angle of 10° is used.

TABLE 1
Thickness of photoresist = 60 nm

| | Thickness of | Threshold | Angle of | Pit | Pit |
|---|---|---|---|---|---|
| | light-absorbing | Value | inclination θ | width | depth |
| | layer (nm) | (mJ/m) | (deg) | (nm) | (nm) |
| Example 1 | 158 | 1.4 | 59.9 | 155 | 53.8 |
| Example 2 | 50 | 2.0 | 65.2 | 155 | 54.0 |
| Example 3 | 93 | 1.6 | 56.2 | 147 | 55.0 |
| Example 4 | 222 | 1.4 | 55.1 | 131 | 56.2 |
| Comparative | None | — | 33.7 | 211 | 56.2 |
| Example 1 | | | | | |
| Comparative | None | — | — | — | — |
| Example 2 | | | | | |
| Reference | None (thickness | 8.0 | Not | [symbol] | [symbol] |
| Example | of photoresist: | | measured | | |
| | 170) | | | | |

From Table 1, it is found that the threshold value becomes larger as the light-absorbing layer becomes thinner. It is also found that, in the case where the light-absorbing layer is thick, the information pits can be formed even if the power of the laser beam is low.

Moreover, from comparison of the thickness of the light-absorbing layer and the threshold value between Examples 1 and 4, it is found that the threshold value does not become small when the thickness of the light-absorbing layer exceeds about 160 nm.

In Comparative Example 1, information pits were formed by irradiating a photoresist layer having the same thickness as the photoresist layers in Examples with laser (1.5 mJ/m) to form a latent image and then developing the latent image, without forming the light-absorbing layer. In Comparative Example 2, a photoresist layer having a thickness of 60 nm was formed without forming the light-absorbing layer. In Reference Example, a resist layer was formed to have a thickness of 170 nm without forming the light-absorbing layer.

Table 1 shows that the angle of inclination in Comparative Example 1 is considerably smaller than those in Examples 1 through 4.

In addition, in Comparative Example 2, the pattern (concave portion) could not be formed even when the power of the laser beam was 16.0 mJ/m. In Reference Example, although the pits could be formed without forming the light-absorbing layer, the threshold value was four times or more, as compared with those in Examples 1 through 4, meaning that it required high power laser.

Next, Example 5 and Comparative Example 3 are shown in Table 2. In Example 5, the thickness of the photoresist layer was set to 30 nm, that was the thickness for a groove, and the thickness of the light-absorbing layer was set to 143 nm. Other conditions in Example 5 were the same as those in Example 1. In Comparative Example 3, except that the thickness of the photoresist layer was set to 30 nm, the conditions were the same as those in Comparative Example 1.

TABLE 2
Thickness of photoresist = 30 nm

| | Thickness of | Angle of | Groove | Groove |
|---|---|---|---|---|
| | light-absorbing | inclination θ | width | depth |
| | layer (nm) | (deg) | (nm) | (nm) |
| Example 5 | 143 | 23.4 | 147 | 25.4 |
| Comparative | None | 8.0 | 178 | 13.9 |
| Example 3 | | | | |

Table 2 also shows that the angle of inclination θ became smaller than those in Examples 1 through 4 because of the thickness reduction of the photoresist layer. The angle of inclination θ in Example 5 is larger than that in Comparative Example 3. Therefore, it is found that a sharper convexo-concave pattern than that formed by the conventional technique is formed.

### INDUSTRIAL APPLICABILITY

Since the present invention is configured as described above, the present invention has excellent effects that a sharp convexo-concave pattern having a large angle of inclination can be formed on a photoresist master, and a convexo-concave pattern of a stamper intermediate, of a stamper, and of an optical recording medium fabricated using the same can be made sharp with high precision.

1-15. (canceled)

16. A fabrication method of a photoresist master comprising the steps of: forming at least a light-absorbing layer and a photoresist layer on a substrate in that order; and forming a convexo-concave pattern by irradiating the photoresist layer with an active energy beam from a surface of the photoresist layer opposite to a surface thereof that is in contact with the light-absorbing layer to remove photoresist at an irradiated portion of the photoresist layer.

17. A fabrication method of a stamper used for fabricating an optical recording medium, comprising the steps of: forming at least a light-absorbing layer and a photoresist layer on a substrate in that order; forming a convexo-concave pattern to fabricate a photoresist master by irradiating the photoresist layer with an active energy beam from a surface of the photoresist layer opposite to a surface thereof that is in contact with the light-absorbing layer to remove photoresist at an irradiated portion of the photoresist layer; forming a metal thin layer on the convexo-concave pattern in the photoresist master; forming a metal layer on the metal thin layer by electro-plating; and forming a stamper by separating the metal thin layer and the metal layer from the photoresist master.

18. The fabrication method of a stamper used for fabricating an optical recording medium according to claim 17, wherein the active energy beam for forming the convexo-concave pattern is an electromagnetic wave having a wavelength in an ultraviolet region.

19. The fabrication method of a stamper used for fabricating an optical recording medium according to claim 17, wherein the stamper used for fabricating an optical recording medium has a shape of a disc, a forming pitch of the convexo-concave pattern in a disc-radial direction is smaller than 0.6 μm, and irradiation with the active energy beam is performed to satisfy 0.75t<θ<1.4t so as to form a concave portion where a depth of the convexo-concave pattern is t nm and an angle of inclination of a sidewall face of the convexo-concave pattern at a level of t/2 is θ°.

20. The fabrication method of a stamper used for fabricating an optical recording medium according to claim 18, the stamper used for fabricating an optical recording medium has a shape of a disc, a forming pitch of the convexo-concave pattern in a disc-radial direction is smaller than 0.6 μm, and irradiation with the active energy beam is performed to satisfy 0.75t<θ<1.4t so as to form a concave portion where a depth of the convexo-concave pattern is t nm and an angle of inclination of a sidewall face of the convexo-concave pattern at a level of t/2 is θ°.

21. A stamper used for fabricating an optical recording medium, having a convexo-concave pattern on a surface thereof formed in advance, wherein the stamper is fabricated by the fabrication method according to claim 17.

22. A stamper used for fabricating an optical recording medium, having a convexo-concave pattern on a surface thereof formed in advance, wherein the stamper is fabricated by the fabrication method according to claim 18.

23. A stamper used for fabricating an optical recording medium, having a convexo-concave pattern on a surface thereof formed in advance, wherein the stamper is fabricated by the fabrication method according to claim 19.

24. A stamper used for fabricating an optical recording medium, having a convexo-concave pattern on a surface thereof formed in advance, wherein the stamper is fabricated by the fabrication method according to claim 20.

25. A stamper used for fabricating an optical recording medium, comprising a metal thin layer and a metal layer and having a convexo-concave pattern on a surface thereof formed in advance, wherein the stamper is fabricated by the steps of: forming at least a light-absorbing layer and a photoresist layer on a substrate in that order; forming a convexo-concave pattern to fabricate a photoresist master by irradiating the photoresist layer with an active energy beam from a surface of the photoresist layer opposite to a surface thereof that is in contact with the light-absorbing layer to remove photoresist at an irradiated portion of the photoresist layer; forming a metal thin layer on the convexo-concave pattern in the photoresist master; forming a metal layer on the metal thin layer by electro-plating; and forming a stamper by separating the metal thin layer and the metal layer from the photoresist master.

26. The stamper according to claim 25, wherein the active energy beam for forming the convexo-concave pattern is an electromagnetic wave having a wavelength in an ultraviolet region.

27. The stamper according to claim 25, wherein the stamper used for fabricating an optical recording medium has a shape of a disc, a forming pitch of the convexo-concave pattern in a disc-radial direction is smaller than 0.6 μm, and irradiation with the active energy beam is performed to satisfy 0.75t<θ<1.4t so as to form a concave portion where a depth of the convexo-concave pattern is t nm and an angle of inclination of a sidewall face of the convexo-concave pattern at a level of t/2 is θ°.

28. The stamper according to claim 26, wherein the stamper used for fabricating an optical recording medium has a shape of a disc, a forming pitch of the convexo-concave pattern in a disc-radial direction is smaller than 0.6 μm, and irradiation with the active energy beam is performed to satisfy 0.75t<θ<1.4t so as to form a concave portion where a depth of the convexo-concave pattern is t nm and an angle of inclination of a sidewall face of the convexo-concave pattern at a level of t/2 is θ°.

29. A stamper used for fabricating an optical recording medium, having a convexo-concave pattern on a surface thereof formed in advance, wherein a forming pitch of the convexo-concave pattern in a disc-radial direction is smaller than 0.6 μm, and the convexo-concave pattern satisfies 0.75t<θ<1.4t where a depth of the convexo-concave pattern is t nm and an angle of inclination of a sidewall face of the convexo-concave pattern at a level of t/2 is θ°.

30. A photoresist master comprising: a substrate; a light-absorbing layer formed on the substrate; and a photoresist layer formed to be in contact with the light-absorbing layer, wherein the photoresist layer has a convexo-concave pattern formed by directly removing a part of photoresist at the photoresist layer by irradiation with an active energy beam.

31. A stamper intermediate comprising: a substrate; a light-absorbing layer formed on the substrate; a photoresist layer formed to be in contact with the light-absorbing layer, the photoresist layer having a convexo-concave pattern formed by directly removing a part of photoresist at the photoresist layer by irradiation with an active energy beam; a metal thin layer formed on the convexo-concave pattern; and a metal layer formed on the metal thin layer by electro-plating.

32. A disc-shaped optical recording medium in which a convexo-concave pattern including at least one of information pits and a groove for guiding a laser beam is formed, wherein a forming pitch of the convexo-concave pattern in a disc-radial direction is smaller than 0.6 μm, and the convexo-concave pattern satisfies 0.75t<θ<1.4t where a depth of the convexo-concave pattern is t nm and an angle of inclination of a sidewall face of the convexo-concave pattern at a level of t/2 is θ°.

33. The optical recording medium according to claim 30, wherein the disc-shaped optical recording medium is fabricated using a stamper that has been fabricated by the steps of: forming at least a light-absorbing layer and a photoresist layer on a substrate in that order; forming a convexo-concave pattern to fabricate a photoresist master by irradiating the photoresist layer with an active energy beam from a surface of the photoresist layer opposite to a surface thereof that is in contact with the light-absorbing layer to remove photoresist at an irradiated portion of the photoresist layer; forming a metal thin layer on the convexo-concave pattern in the photoresist master; forming a metal layer on the metal thin layer by electro-plating; and forming a stamper by separating the metal thin layer and the metal layer from the photoresist master.

34. The optical recording medium according to claim 33, wherein the active energy beam for forming the convexo-concave pattern is an electromagnetic wave having a wavelength in an ultraviolet region.

35. The optical recording medium according to claim 32, fabricated using a stamper having a convexo-concave pattern on a surface thereof formed in advance, wherein the stamper is fabricated by forming at least a light-absorbing layer and a photoresist layer on a substrate in that order; forming a convexo-concave pattern to fabricate a photoresist master by irradiating the photoresist layer with an active energy beam from a surface of the photoresist layer opposite to a surface thereof that is in contact with the light-absorbing layer to remove photoresist at an irradiated portion of the photoresist layer; forming a metal thin layer on the convexo-concave pattern in the photoresist master; forming a metal layer on the metal thin layer by electro-plating; and forming a stamper by separating the metal thin layer and the metal layer from the photoresist master.
